(19) United States
(12) Patent Application Publication
(10) Pub. No.: US 2011/0236633 A1
(43) Pub. Date: Sep. 29, 2011

(54) Apparatus for manufacturing glass plate and method of manufacturing glass plate

(76) Inventors: Tatsuya TAKAYA, Otsu-shi (JP); Keiji Takagi, Otsu-shi (JP); Michiharu Eta, Otsu-shi (JP)

(21) Appl. No.: 13/038,685

(22) Filed: Mar. 2, 2011

(30) Foreign Application Priority Data
Mar. 23, 2010 (JP) 2010-066448

(51) Int. Cl. B32B 17/00; B32B 33/00; C03B 17/06

(52) U.S. Cl. 428/141; 65/195; 65/90

(57) ABSTRACT

Provided is a thin glass plate manufacturing apparatus by: pouring a molten glass (G) into an overflow trough (2) formed in a top of a forming body (1); allowing the molten glass (G) which is overflown from the overflow trough (2) over a top planar portion (3) of the forming body (1) on each side of the overflow trough (2) to flow downward along an outer surface portion (4) having a substantially wedge-like shape of the forming body (1); and fusing and integrating the molten glass (G) at a lower end of the forming body (1), thereby forming a thin glass plate having a thickness equal to or less than 500 μm, in which a molten glass contact surface of at least the top planar portion (3) of an outer surface of the forming body (1) has a maximum height roughness (Rz) of equal to or less than 10 μm.

### TECHNICAL FIELD

The present invention relates to an improvement in a technology for manufacturing a thin glass plate by an overflow downdraw method.

### BACKGROUND ART

As is well known, as represented by a glass substrate for a flat panel display (FPD) such as a liquid crystal display, a plasma display, or an organic light-emitting diode (OLED) display, and a glass substrate for an OLED lighting, glass plates utilized in various fields may be required to satisfy a rigorous product quality requirement for surface defects and waviness.

As a method of manufacturing a glass plate of this kind, an overflow downdraw method is utilized for obtaining a glass surface which is smooth and free of defects.

This manufacturing method includes: pouring a molten glass into an overflow trough in a top of a forming body; allowing the molten glass which is overflown over both sides from the overflow trough to flow downward through a top planar portion of the forming body and along an outer surface portion having a substantially wedge-like shape of the forming body; and fusing and integrating the molten glass at a lower end of the forming body, thereby continuously forming a single thin glass plate (for example, see Patent Literature 1).

This manufacturing method is characterized in that both front and back surfaces of the thin glass plate thus formed are formed without coming into contact with any area of the forming body, and hence a fire polished surface with extremely high flatness and smoothness and no defects such as flaws can be obtained.

Thus, for example, when the thin glass plate such as the glass substrate for the liquid crystal display having a thickness of about 700 μm, which is currently the mainstream, is manufactured by this manufacturing method, it is possible to ensure a surface accuracy high enough to satisfy the required product quality.

### CITATION LIST

### Patent Literature

[PTL 1] Japanese Patent Application Laid-open No. 2006-298736

### SUMMARY OF INVENTION

### Technical Problem

Incidentally, in recent years, further thickness reduction of a thin glass plate such as a glass substrate for FPD is in fact under way.

However, as the inventors of the present invention used an overflow downdraw method to proceed with further thickness reduction of the thin glass plate, in particular, when manufacturing the thin glass plate having a thickness equal to or less than 500 μm, the thin glass plate to be manufactured by a conventional forming body had an uneven thickness (thickness deviation) which makes it difficult to satisfy a required product quality.

In other words, as the thickness of the thin glass plate has become smaller, the thickness deviation has become more pronounced. The thickness deviation of the thin glass plate does not really matter for the thin glass plate with a relatively large thickness of about 700 μm due to the fact that the thickness deviation is relatively small with respect to the overall thickness, whereas the thickness deviation of the thin glass plate is not negligible for the thin glass plate with a relatively small thickness equal to or less than 500 μm due to the fact that the thickness deviation reaches a large proportion of the overall thickness.

Further, as the thin glass plate becomes thinner, the thin glass plate becomes flexible, and hence the long thin glass plate can be wound in a roll shape to form a glass roll. The glass roll enables a glass to be processed in a Roll to Roll process, with the result that the manufacturing efficiency of various displays and lightings is greatly improved. However, when the thin glass plate is formed into the glass roll, the thin glass plate is laminated in a diametrical direction of the roll, and hence if the thin glass plate has a large thickness deviation in a width direction, differences in thickness become cumulative to thereby cause a variation in a roll diameter in the width direction of the thin glass plate. Consequently, the thin glass plate loses its form as the glass roll.

It is a technical object of the present invention to maintain the thickness deviation (uneven thickness) of the manufactured thin glass plate in an acceptable state capable of ensuring a product quality even when the thin glass plate having a thickness equal to or less than 500 μm is manufactured by the overflow downdraw method.

### Solution to Problem

As a result of an exhaustive study by the inventors of the present invention, it has been found that a surface accuracy of an outer surface of a forming body influences a thickness deviation of a thin glass plate to be manufactured. More specifically, if the outer surface of the forming body has an unsuitable surface accuracy and a large roughness, due to unevenness of the outer surface of the forming body, a thickness of a molten glass flowing on the outer surface of the forming body is easily increased or decreased in some places. Therefore, a thickness of the thin glass plate formed by fusing and integrating such a molten glass at a lower end of the forming body may have unevenness (surface height deviation).

Therefore, an apparatus according to the present invention invented to solve the above-mentioned problem is characterized by a thin glass plate manufacturing apparatus having a structure in which the thin glass plate is obtained by: pouring a molten glass into an overflow trough formed in a top of a forming body; allowing the molten glass which is overflown from the overflow trough over a top planar portion of the forming body on each side of the overflow trough to flow downward along an outer surface portion having a substantially wedge-like shape of the forming body; and fusing and integrating the molten glass at a lower end of the forming body, thereby forming a thin glass plate having a thickness equal to or less than 500 μm, in which a molten glass contact surface of at least the top planar portion of an outer surface of the forming body has a maximum height roughness Rz of equal to or less than 10 μm. Here, the “maximum height roughness Rz” is the sum of a maximum peek height value and a maximum valley depth value of an outline curve of the outer surface of the forming body in a sampling length, and complies with JIS B0601:2001 (the same shall apply hereinafter).

In other words, the top planar portion included in the outer surface of the forming body is a portion with which the molten glass in a high-temperature state overflown from the overflow trough first comes into contact, and thus is a portion in which deformation of the molten glass is most likely to occur. Most of uneven thickness of the molten glass may occur due to a surface accuracy in this portion. Thus, by optimizing the surface accuracy of the molten glass contact surface of at least the top planar portion of the outer surface of the forming body, the uneven thickness of the molten glass can be effectively reduced.

If the maximum height roughness Rz of the molten glass contact surface of the top planar portion is set to fall within the above-mentioned numerical range, a difference between a maximum value and a minimum value of the thickness of the molten glass flowing on the top planar portion is well reduced. As a result, the uneven thickness of the molten glass flowing on the outer surface of the forming body can be reduced as much as possible. Thus, the thickness deviation of the thin glass plate formed by fusing and integrating the molten glass at the lower end of the forming body is maintained in an acceptable state capable of ensuring a product quality.

In the above-mentioned configuration, a molten glass contact surface of the outer surface portion of the outer surface of the forming body has a maximum height roughness Rz of equal to or less than 10 μm.

In this way, each of the top planar portion and the outer surface portion of the forming body, which forms a passage of the molten glass which is overflown from the overflow trough to be fused and integrated at the lower end of the forming body, has an optimized surface accuracy, and hence the uneven thickness of the molten glass moving along the outer surface of the forming body is more reliably suppressed. Thus, the thickness deviation of the thin glass plate to be manufactured can be more reliably reduced.

A method according to the present invention invented to solve the above-mentioned problem is characterized by a thin glass plate manufacturing method, including: pouring a molten glass into an overflow trough formed in a top of a forming body; allowing the molten glass which is overflown from the overflow trough over a top planar portion of the forming body on each side of the overflow trough to flow downward along an outer surface portion having a substantially wedge-like shape of the forming body; and fusing and integrating the molten glass at a lower end of the forming body, thereby forming a thin glass plate having a thickness equal to or less than 500 μm, in which the method is carried out by using the forming body having a molten glass contact surface of at least the top planar portion of an outer surface of the forming body has a maximum height roughness Rz of equal to or less than 10 μm.

According to this method, it is possible to attain the effect similar to that of the corresponding configuration already described above.

In the above-mentioned method, the molten glass contact surface out of the outer surface portion of the outer surface of the forming body has a maximum height roughness Rz of equal to or less than 10 μm.

In this way, it is possible to attain the effect similar to that of the corresponding configuration already described above.

It is preferred that a thin glass plate having a thickness equal to or less than 500 μm, which is formed by the thin glass plate manufacturing method described above, have a maximum height roughness Rz of equal to or less than 5 μm.

In other words, if the thin glass plate having the maximum height roughness of the surface within the above-mentioned numerical range is used, high flatness and smoothness to the extent that allows the thin glass plate to be used as a glass substrate for FPD without any problems can be ensured.

In this case, the thin glass plate is preferably a glass substrate for FPD.

In other words, the glass substrate for FPD among thin glass plates is required to satisfy a rigorous product quality, and hence a glass substrate of this kind can make the most of advantages which can contribute to the present invention.

### ADVANTAGEOUS EFFECTS OF INVENTION

As described above, according to the present invention, even when a thin glass plate having a thickness equal to or less than 500 μm is manufactured by an overflow downdraw method, a surface accuracy of an outer surface of a forming body which is brought into contact with a molten glass is optimized, and hence the surface accuracy of the manufactured thin glass plate can be reliably ensured.

### BRIEF DESCRIPTION OF DRAWINGS

FIG. 1 An enlarged perspective view illustrating a main part of a thin glass plate manufacturing apparatus according to an embodiment of the present invention.

FIG. 2 A cross-sectional view taken along the line A-A of FIG. 1.

FIG. 3 A graph showing evaluation results according to examples.

### DESCRIPTION OF EMBODIMENT

Hereinafter, an embodiment according to the present invention is described with reference to the accompanying drawings.

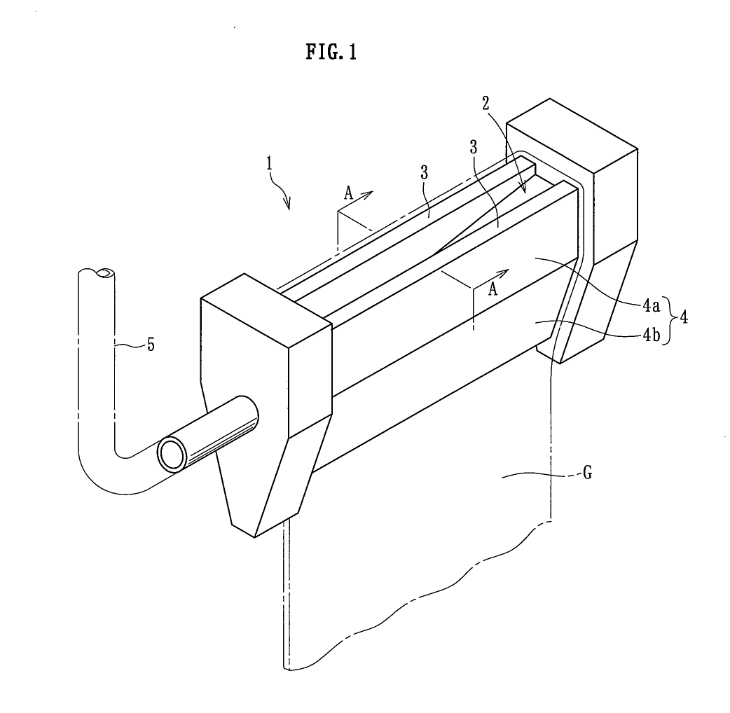

FIG. 1 is an enlarged perspective view illustrating a main part of a thin glass plate manufacturing apparatus according to an embodiment of the present invention. As illustrated in this figure, the thin glass plate manufacturing apparatus is used to manufacture a thin glass plate having a thickness equal to or less than 500 μm (preferably equal to or less than 300 μm, more preferably equal to or less than 200 μm, and most preferably equal to or less than 100 μm), and includes a forming body 1 for carrying out an overflow downdraw method.

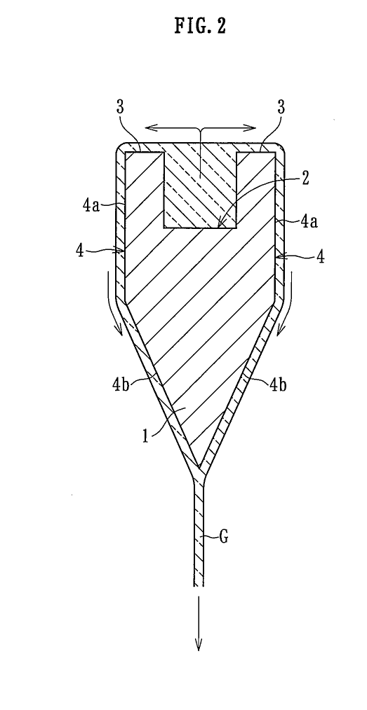

As illustrated in FIGS. 1 and 2, the forming body 1 is elongated along a direction corresponding to a width direction of the thin glass plate to be manufactured, and includes an overflow trough 2 formed along its longitudinal direction in the top thereof and a pair of outer surface portions 4 gradually approaching each other in a downward direction so as to form a substantially wedge-like shape.

A molten glass G is poured into the overflow trough 2 formed in the top of the forming body 1. The molten glass G which is overflown over both sides of the overflow trough 2 flows through top planar portions 3 of the forming body 1 extending laterally from both upper end opening edges of the overflow trough 2 and flows downward along both of the outer surface portions 4 having the substantially wedge-like shape of the forming body 1. The molten glass G flowing downward along both of the outer surface portions 4 of the forming body 1 is fused and integrated at a portion of a lower end of the forming body 1, which is referred to as a root, and hence a single thin glass plate is continually formed from the molten glass G. Here, the top planar portion 3 functions as a weir for adjusting a flow rate of the molten glass G flowing downward along the outer surface portion 4.

The outer surface portions 4 of the forming body 1 are each configured to include a vertical surface portion 4a and an inclined surface portion 4b vertically connected to each other. An intersection point of the inclined surface portions 4b located below both of the outer surface portions 4 is the portion referred to as the root as described above. Further, the molten glass G is supplied into the overflow trough 2 through a supply pipe 5 coupled to one end in the longitudinal direction of the overflow trough 2.

A maximum height roughness Rz of a molten glass contact surface of each of the top planar portion 3 and the outer surface portion 4, of an outer surface of the forming body 1, is set to be equal to or less than 10 μm. Here, the molten glass contact surface means that if the top planar portion 3 and the outer surface portion 4 have any portion with which the molten glass G does not come into contact, surface properties of the noncontact portion are not taken into consideration. Further, the maximum height roughess Rz complies with JIS B0601:2001 and is measured with a sampling length set to 5 mm.

When the thin glass plate manufacturing apparatus configured as described above is used to manufacture the thin glass plate, the thin glass plate having a thickness equal to or less than 500 μm and the maximum height roughness Rz of the surface equal to or less than 5 μm can be obtained. Thus, even for a product which requires a high product quality such as a glass substrate for a liquid crystal display, such a requirement can be well satisfied.

Such a thin glass plate can be manufactured for the reason that the maximum height roughness Rz of the molten glass contact surface of each of the top planar portion 3 and the outer surface portion 4, of the outer surface of the forming body 1, is set to be equal to or less than 10 μm.

In other words, the top planar portion 3 included in the outer surface of the forming body 1 is a portion with which the molten glass in a high-temperature state overflown from the overflow trough 2 first comes into contact, and thus is a portion in which deformation of the molten glass G is most likely to occur. Most of uneven thickness of the molten glass G may occur due to a surface accuracy in this portion. Thus, by optimizing the surface accuracy of at least the molten glass contact surface of the top planar portion 3 of the outer surface of the forming body 1, the uneven thickness of the molten glass G can be effectively reduced.

If the maximum height roughness Rz of the molten glass contact surface of the top planar portion 3 is set to be equal to or less than 10 μm, a difference between a maximum value and a minimum value of the thickness of the molten glass G flowing on the top planar portion 3 is well reduced. As a result, the uneven thickness of the molten glass G flowing on the outer surface of the forming body 1 can be reduced as much as possible.

Moreover, in this embodiment, in addition to the molten glass contact surface of the top planar portion 3, the maximum height roughness Rz of the molten glass contact surface of the outer surface portion 4 is also set to be equal to or less than 10 μm. Thus, even while the molten glass G is flowing downward along the outer surface portion 4, there is no risk of the uneven thickness of the molten glass G being increased and deteriorated.

Thus, in the root at the lower end of the forming body 1, the molten glass G with less uneven thickness is fused and integrated with each other. As a result, a fused portion is less likely to influence both front and back surfaces of the manufactured thin glass plate, and, as described above, the thin glass plate of a good surface accuracy having the maximum height roughness Rz of the surface equal to or less than 5 μm can be obtained.

Note that, the present invention is not limited to the above-mentioned embodiment. For example, in the above-mentioned embodiment, description is made of the case where the maximum height roughness Rz of the molten glass contact surface of each of the top planar portion 3 and the outer surface portion 4 of the forming body 1 is set to be equal to or less than 10 μm. However, for example, only the maximum height roughness Rz of the molten glass contact surface of the top planar portion 3 may be set to satisfy the above-mentioned numerical range, or the maximum height roughness Rz of the molten glass contact surface of each of the top planar portion 3 and the root of the outer surface portion 4 may be set to satisfy the above-mentioned numerical range.

### EXAMPLES

In order to demonstrate the usefulness of the present invention, forming bodies having different maximum height roughnesses Rz of an outer surface were used to manufacture glass substrates for a liquid crystal display with various thicknesses equal to or less than 500 μm by an overflow downdraw method, and evaluation tests were carried out to measure the maximum height roughnesses Rz of a surface of the manufactured glass substrates. In other words, because uneven thickness (thickness deviation) of the thin glass plate appears in unevenness of the surface of the thin glass plate, the thickness deviation of the thin glass plate can be evaluated by measuring the maximum height roughness Rz of the surface.

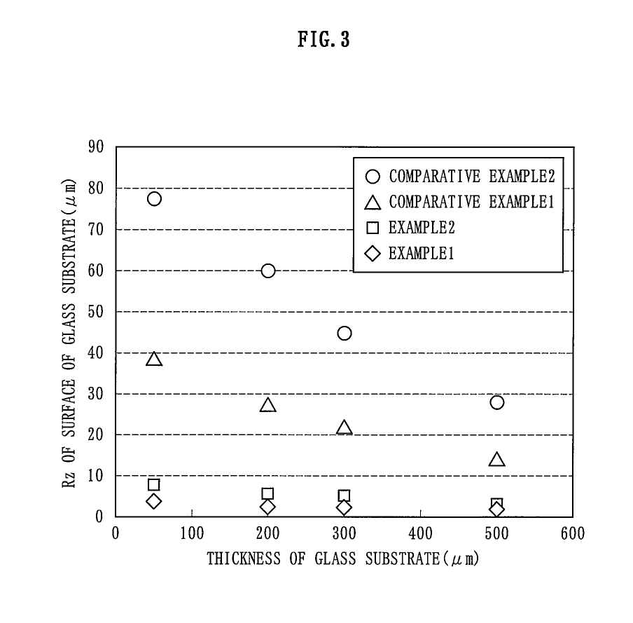

Specifically, each evaluation test was carried out by using: in Example 1, the forming body having the maximum height roughness Rz of the molten glass contact surface of each of a top planar portion and an outer surface portion of 5 μm; in Example 2, the forming body having the maximum height roughness Rz of the molten glass contact surface of each of the top planar portion and the outer surface portion of 10 μm; in Comparative example 1, the forming body having the maximum height roughness Rz of the molten glass contact surface of each of the top planar portion and the outer surface portion of 50 μm; and in Comparative example 2, the forming body having the maximum height roughness Rz of the molten glass contact surface of each of the top planar portion and the outer surface portion of 100 μm. Results of those evaluation tests are shown in FIG. 3.

As shown in FIG. 3, in all of Examples 1 and 2 as well as Comparative examples 1 an 2, it can be recognized that as the thickness of the glass substrate to be manufactured becomes smaller, the maximum height roughness Rz of the surface of the glass substrate tends to increase. However, the tendency of increase is extremely low in Examples 1 and 2, whereas the tendency of increase is extremely high in Comparative examples 1 and 2.

Moreover, it can be recognized that in Comparative examples 1 and 2, at the point in time when the thickness of the glass substrate is 500 μm, Rz of the surface of the glass substrate is already above 10 μm, which is a product quality standard required for the glass substrate for the liquid crystal display, and as the thickness of the glass substrate becomes smaller to be 300 μm, 200 μm, and 50 μm, Rz significantly exceeds the product quality standard, with the result that it is extremely difficult to ensure the product quality. Note that, this tendency appears more strongly in Comparative example 2, which uses the forming body with less surface accuracy than the forming body of Comparative example 1.

In contrast, in Examples 1 and 2, at the point in time when the thickness of the glass substrate is 500 μm, Rz of the surface of the glass substrate shows a good result which is significantly less than 10 μm, which is required for the product quality, and as the thickness of the glass substrate becomes smaller to be 300 μm, 200 μm, and 50 μm, Rz is less than 10 μm, which is required for the product quality, for all the thicknesses. In other words, in Examples 1 and 2, all the glass substrates having the thickness equal to or less than 500 μm show good results which satisfy the product quality standard. In particular, in Example 1, even when the thickness of the glass substrate is 50 μm, the maximum height roughness Rz of the glass substrate is equal to or less than 5 μm, which results in realization of a high surface accuracy, that is, an acceptable thickness deviation.

Thus, from those results, it can also be determined that the product quality of the glass substrate having the thickness equal to or less than 50 μm can be reliably ensured by setting Rz of the outer surface of the forming body to be equal to or less than 10 μm, and preferably equal to or less than 5 μm.

### REFERENCE SIGNS LIST

1 forming body
2 overflow trough
3 top planar portion
4 outer surface portion
4a vertical surface portion
4b inclined surface portion
5 supply pipe
G molten glass

1. A thin glass plate manufacturing apparatus having a structure in which the thin glass plate is obtained by: pouring a molten glass into an overflow trough formed in a top of a forming body; allowing the molten glass which is overflown from the overflow trough over a top planar portion of the forming body on each side of the overflow trough to flow downward along an outer surface portion having a substantially wedge-like shape of the forming body; and fusing and integrating the molten glass at a lower end of the forming body, thereby forming a thin glass plate having a thickness equal to or less than 500 μm,
wherein a molten glass contact surface of at least the top planar portion of an outer surface of the forming body has a maximum height roughness Rz of equal to or less than 10 μm.

2. The thin glass plate manufacturing apparatus according to claim 1,
wherein a molten glass contact surface of the outer surface portion of the outer surface of the forming body has a maximum height roughness Rz of equal to or less than 10 μm.

3. A thin glass plate manufacturing method, comprising:
pouring a molten glass into an overflow trough formed in a top of a forming body;
allowing the molten glass which is overflown from the overflow trough over a top planar portion of the forming body on each side of the overflow trough to flow downward along an outer surface portion having a substantially wedge-like shape of the forming body; and
fusing and integrating the molten glass at a lower end of the forming body, thereby forming a thin glass plate having a thickness equal to or less than 500 μm,
wherein the method is carried out by using the forming body having a molten glass contact surface of at least the top planar portion of an outer surface of the forming body has a maximum height roughness Rz of equal to or less than 10 μm

4. The thin glass plate manufacturing method according to claim 3,
wherein the molten glass contact surface out of the outer surface portion of the outer surface of the forming body has a maximum height roughness Rz of equal to or less than 10 μm.

5. A thin glass plate having a thickness equal to or less than 500 μm, which is formed by the thin glass plate manufacturing method according to claim 3, wherein a surface of the thin glass plate has a maximum height roughness Rz of equal to or less than 5 μm.

6. The thin glass plate according to claim 5,
wherein the thin glass plate comprises a glass substrate for a flat panel display.

7. A thin glass plate having a thickness equal to or less than 500 μm, which is formed by the thin glass plate manufacturing method according to claim 4, wherein a surface of the thin glass plate has a maximum height roughness Rz of equal to or less than 5 μm.

8. The thin glass plate according to claim 7,
wherein the thin glass plate comprises a glass substrate for a flat panel display.
